(19) United States
(12) Patent Application Publication
(10) Pub. No.: US 2005/0121565 A1
(43) Pub. Date: Jun. 9, 2005

(54) Adjustable musical instrument stand

(75) Inventor: Jeffrey A. Johnson, Omaha, NE (US)

Correspondence Address: SUITER WEST PC LLO, 14301 FNB PARKWAY, SUITE 220, OMAHA, NE, 68154, US

(73) Assignee: Solid Stand, Inc.

(21) Appl. No.: 11/031,272

(22) Filed: Jan. 7, 2005

Related U.S. Application Data
(62) Division of application No. 10/730,473, filed on Dec. 8, 2003.

(51) Int. Cl. A47F 5/00; A47F 7/00; F16M 11/00; F16M 13/00; G10D 3/00; G10G 5/00

(52) U.S. Cl. 248/125.1

(57) ABSTRACT

The invention is a musical instrument stand that can be vertically adjusted while the instrument remains on the stand. Ideally, the mechanism that alters the height of the instrument will be operable by foot, so that the operator will be able to adjust the stand while playing the instrument.

### CROSS REFERENCE TO RELATED APPLICATIONS

The present application is a divisional of co-pending U.S. application Ser. No. 10/730,473, filed on Dec. 8, 2003, which is herein incorporated by reference in its entirety.

### FIELD OF THE INVENTION

This present invention generally relates to the art of stands for musical instruments, primarily keyboards and other horizontally situated instruments such as keyboards, and particularly to the adjustability of such stands with the instrument mounted thereon.

### BACKGROUND OF THE INVENTION

Musical instrument stands of various types are well known and widely used. Typically such stands consist of multi-legged structures that support either the instrument or an undercarriage. Some are composed of a base and a single support that holds a frame on which the instrument rests (a “pillar” configuration). Few of the stands are adjustable in height.

One instance of such a stand is described in U.S. Pat. No. 5,467,953. That patent describes an instrument stand having essentially two legs, each leg having an end for contact with the floor and an end for supporting the instrument (an “X” configuration). The legs were pivotably joined at their middles, and the angle between them adjusted to adjust the height of the instrument. The adjustment was regulated by a locking gear mechanism having a plurality of working positions. Another such instance of a stand is described in U.S. Pat. No. 5,984,245. That patent teaches a similar “X” configuration instrument stand having as its positioning device an assembly comprising a control rod, a spring and two positioning discs. The assembly is manipulated by handlebars on each leg, and the angle between the legs is adjusted accordingly. These designs and others that have been designed have failed to provide a stand that may be adjusted with the instrument still mounted on the stand.

### SUMMARY OF THE INVENTION

The invention therefore has, as a primary object, the improvement of musical instrument stands in such a way that they can be adjusted while the instrument remains on the stand. This object is met by different mechanisms appropriate to the type of stand employed. Ideally, each such mechanism will be operable by foot, so that the operator will be able to adjust the stand while playing the instrument.

One example of such a mechanism that could be employed on a stand having two legs in an “X” configuration would be a powered piston attached to each of the two legs and adapted to draw the legs toward or away from each other. Another example of such a mechanism that could be employed on a stand having a single “pillar” configuration would be to have the pillar adjustable support a support frame, and have a winch or similar drive adjust the height of the frame. Such a construction makes it possible to move the instrument from a first position, where, perhaps, the user is sitting at a keyboard, to a second position, where the user is standing at the keyboard, without having to remove the instrument from the stand, and without having to stop playing the instrument.

The invention is described in the following with reference to embodiment examples shown in the drawings.

Additional objects of the invention will be set forth in the description that follows, and will become apparent to those skilled in the art upon examination of the following.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The feature advantages of the present invention will become more clearly appreciated as a description of the invention is made with reference to the appended drawings. In the drawings:

FIG. 1 is a side elevational view of the invention in a “pillar” configuration.

FIG. 2 is a front elevational view of the invention in a “pillar” configuration.

FIG. 3 is a side elevational view of the invention in an “X” configuration.

FIG. 4 is a front elevational view of the invention in an “X” configuration.

FIG. 5 is a side elevational view of the invention in a “table” configuration.

FIG. 6 is a front elevational view of the invention in a “table” configuration.

### DETAILED DESCRIPTION OF THE INVENTION

Preferred embodiments of the present invention will be described below by making reference to the drawings.

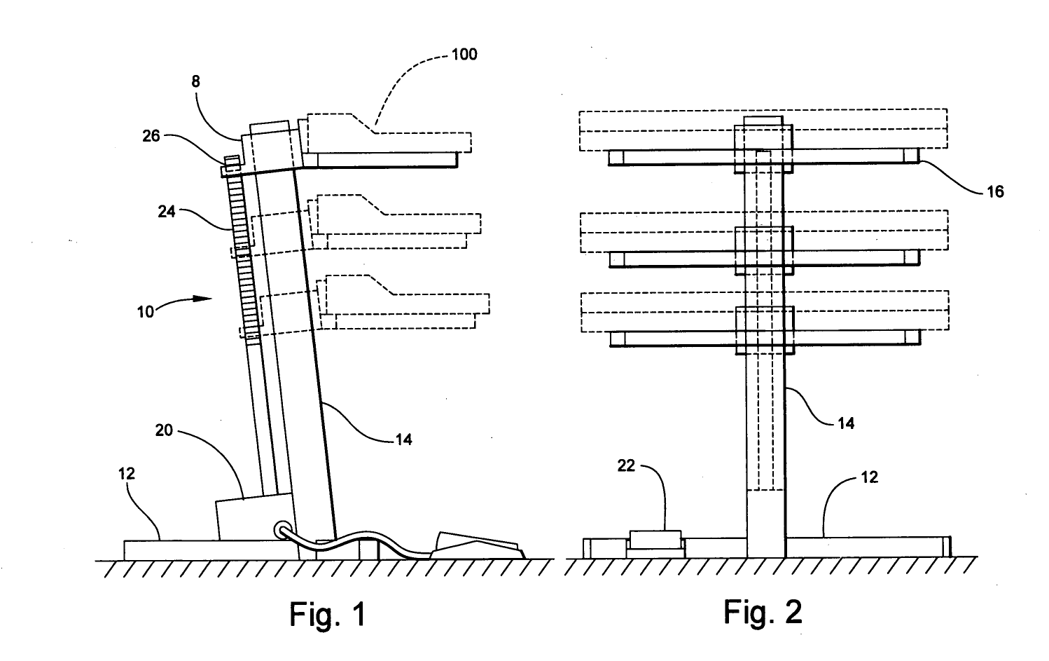

The present invention was developed for use with keyboard instruments. The stand, as shown in FIGS. 1-6, may take one of several forms.

In the first example of the invention, as shown in FIGS. 1-2, the stand 10 includes a base 12. The base 12 includes multiple legs splayed outwardly from a central point. The legs may be adjustable for the purposes of conforming to an uneven surface, or may be adjustable in length to provide optimal stability. The stand 10 also comprises at least one substantially vertical pillar 14 extending upwardly from the base 12.

A keyboard support 16 is supported on the pillar 14. The keyboard support 16 comprises at least one substantially horizontal member on which a keyboard 100 may be mounted. Ideally, for stability purposes, the keyboard support 16 should have a single broad surface, as shown, or have two or more horizontal members that are spaced widely enough to prevent movement of the keyboard when the keyboard is played.

The keyboard support 16 should not be affixed to the pillar 14, but should be adjustably mounted on the pillar 14 so that it may move vertically along the length of the pillar 14. This may be achieved by providing the keyboard support 16 with a collar 18 that fits around the pillar 14. To provide ease of movement, the collar 18 may incorporate rollers, ball bearings, low friction material lining, or other such materials as are well known in the art. Alternatively, the keyboard may be mounted to a collar 18 that fits within a chamber (not shown) in the pillar 14. Ideally, in this configuration, the collar 18 should have an exterior horizontal cross-sectional profile substantially equivalent to the interior horizontal cross-sectional profile of the channel in the pillar 14. The instrument stand 10 should also have means for moving the keyboard vertically along the pillar 14. This may be provided by mechanical, hydraulic, or other means. In the example shown, the instrument stand includes an electric motor 20, a foot switch 22, and a vertically disposed, externally threaded screw member 24. The screw member 24 is adapted to fit into an internally threaded aperture 26 in the collar 18. The vertically disposed screw member 24, which is essentially parallel to the pillar 14, is rotated by the electric motor 20. Ideally, the foot switch 22 will include a control that activates the electric motor 20 and turns the screw member 24 selectively in a clockwise or counterclockwise direction. Rotation of the screw member 24 will result in the raising or lowering of the keyboard without removing the keyboard from the keyboard support 16.

Another mechanism that may be used would be a winch and pulley system (not shown). The pulley may be included at the top of the pillar 14 or at the top of the interior chamber of the pillar. The mechanism may include a winch at the base of the stand 10 and a cable that extends either through the chamber or along the pillar to the pulley and downwardly to the collar 18. Activation of the winch would pull the collar 18 upwardly and raise the keyboard. Release of the winch would allow the keyboard to be drawn downwardly by force of gravity. Alternatively, the cable may be attached to the collar 18 so that it may exert force on the collar 18 selectively from the top and the bottom, and the winch arranged to move the cable in either of two directions such that activation of the winch results in the controlled adjustment of the height of the keyboard without removing the keyboard from the keyboard support 16. A further embodiment of this invention (not shown) would position the winch at the top of the pillar, and would work generally in the manner described.

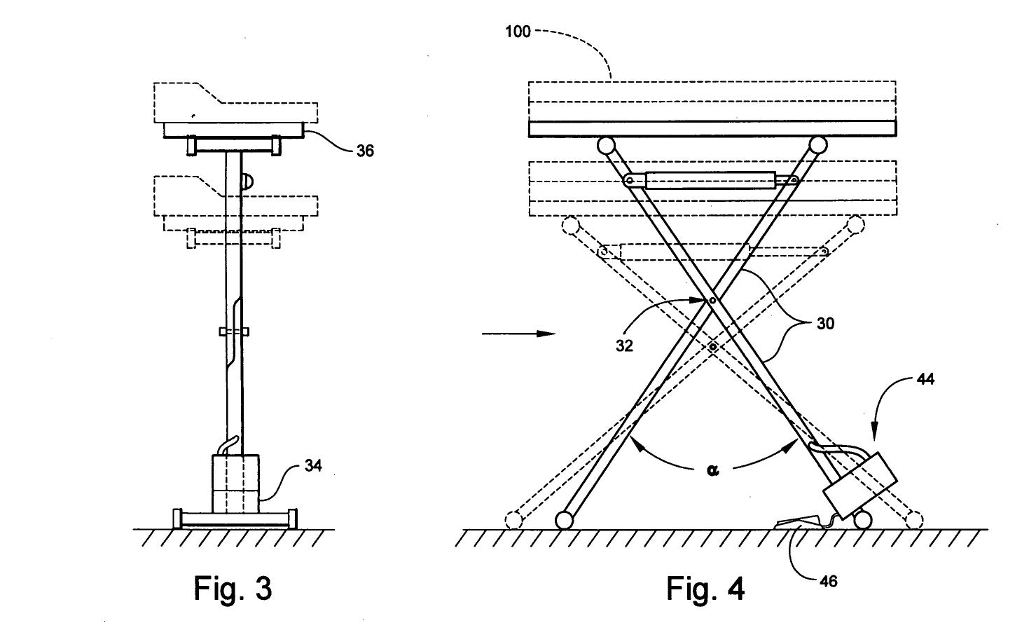

In a second embodiment of the invention, shown in FIGS. 3 and 4, the instrument stand 10′ comprises two legs 30 pivotally joined at a central point 32. Each leg 30 has a bottom end and a top end. The bottom end of each leg should have horizontally extending legs 34 that are adapted to hold the keyboard stand 10′ upright. The top end of the legs 30 should include means to support the keyboard. Although such means may incorporate horizontally extending legs, ideally, the top ends of the legs should engage a horizontal keyboard support 36. The horizontal keyboard support 36 should be adjustably mounted on the top ends of the two legs 30. It should be mounted on the two legs such that the legs 30 may move horizontally along the length of the keyboard support 36. Such a configuration would allow for the raising and lowering of the stand while maintaining the keyboard in a horizontal position. Furthermore, a mechanism may be employed to maintain the keyboard in a central position with relation to the keyboard stand through the use of a twin rack and pinion mechanism (not shown), or other such mechanism well known in the mechanical arts.

The invention further comprises means to adjust the angle between the two legs 30. This may be comprised of a mechanical or hydraulic actuator mounted on the legs between the pivotal center point and the upper or lower ends of the legs 30. As shown in FIG. 4, the means comprises a hydraulic piston 38 having a first end 40 mounted on the first leg and a second end 42 mounted on the second leg. The hydraulic piston is attached to a hydraulic pump 44 that can alter the pressure within the hydraulic piston 38. The pump, ideally, is activated by a foot switch 46. As shown in the drawings, by reducing the pressure in the piston 38, the angle between the legs 30 is reduced and the keyboard is raised without removing the keyboard from the keyboard support 36.

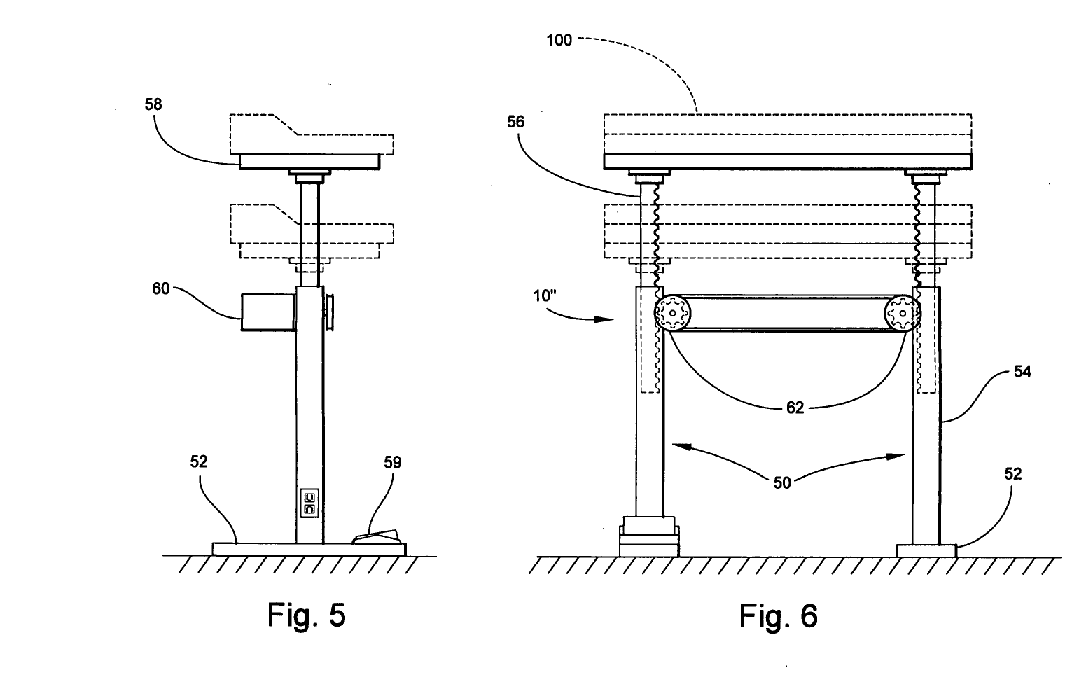

A third embodiment of the invention comprises a traditional table-style stand 10″. The stand 10″ includes at least two vertically disposed legs. The legs will be designed to provide stability to the stand, either by the provision of numerous legs or by the provision of legs providing a large enough base to lend stability to the stand 10″. In the embodiment shown, the stand incorporates two pedestal-type legs 50, each having a base 52 that extends outward horizontally from the plane defined by the two legs. Each leg comprises a base section 54 that is affixed to its base and an adjustable section 56 that is axially adjustably mounted on the base section. The adjustable sections 56 are each affixed to a keyboard support 58 on which the keyboard 100 is mounted. The stand 10″ includes a mechanism, such as those earlier described, to move the adjustable legs axially along the length of the base section, resulting in the raising or lowering of the keyboard. Ideally, the raising or lowering of the keyboard support 58 is effectuated by the activation, by foot switch 59 or other control of a single mechanism, as exemplified by the electric motor 60 that is shown in FIG. 5. Preferably, the adjustable sections of the legs are moved simultaneously by a double rack and pinion mechanism 62 or a chain drive or similar device as are well known in the art.

In the several embodiments of the invention described, the keyboard may remain affixed to the instrument stand and the keyboard height adjusted. No removal of the keyboard is necessary to adjust the height. The design may be changed so that the adjustable keyboard support may raise or lower more than one keyboard. The design may also be used in conjunction with a fixed keyboard support so that a selected number of keyboards may be raised or lowered while at least one keyboard remains stationary. Similarly, more than one adjustable keyboard support may be mounted on a stand.

It will be appreciated that the present invention is not limited to the exact construction that has been described above and illustrated in the accompanying drawings, and that various modifications and changes can be made without departing from the scope and spirit thereof. It is intended that the scope of the invention only be limited by the appended claims. Thus it can be seen that all of the objects of the invention are met.

1-9. (canceled)

10. An adjustable musical instrument stand comprising:
first and second legs pivotally secured together and arranged to define an angle between said first and second legs, each leg having a top end and a bottom end each said top end being adapted to support a musical instrument support;
each said bottom end adapted to support in a generally upright position the adjustable musical instrument stand and the musical instrument support;
means for adjusting the angle between said first and second legs whereby an instrument may be supported on said musical instrument support and may be adjusted to a desired height by adjustment of said musical instrument support without removing the instrument from the adjustable musical instrument stand.

11. The adjustable musical instrument stand of claim 10, whereby said means for adjusting the angle between said first and second legs is electronic.

12. The adjustable musical instrument stand of claim 10, whereby said means for adjusting the angle between said first and second legs is hydraulic.

13. The adjustable musical instrument stand of claim 11, whereby said first and second legs are pivotally secured together at a midpoint and said means for adjusting the angle between said first and second legs comprises: a motor mounted on said first leg between said midpoint and either of said top or bottom ends, a screw drive having a threaded screw, said threaded screw being operatively attached to said motor, a receiving bracket mounted on said second leg between said midpoint and either of said top or bottom ends, said receiving bracket being adapted to receive said threaded screw whereby activation of said motor cases the rotation of the threaded screw and adjusts the angle between said first and second legs and the height of said top ends of said first and second legs.

14. The adjustable musical instrument stand of claim 12 whereby said first and second legs are pivotally secured together at a midpoint and whereby said means for adjusting the angle between said first and second legs comprises: a pump, a piston having first and second ends, said first end being attached to said first leg between said midpoint and either of said top or bottom ends, and said second end being attached to said second leg between said midpoint and either of said top or bottom ends, said piston being in operative communication with said pump such that activation of said pump varies pressure within said piston and causes said piston to vary its length and adjusts the angle between said first and second legs and the height of said top ends of said first and second legs.

15. The adjustable musical instrument stand of claim 10, whereby said means for adjusting the angle between said first and second legs comprises a control that may be manipulated by foot.

16-18. (canceled)

19. An adjustable musical instrument stand, comprising:
first and second legs pivotally secured together and arranged to define an angle between the first and second legs, each leg having a top end and a bottom end each the top end being adapted to support a musical instrument support;
each the bottom end adapted to support in a generally upright position the adjustable musical instrument stand and the musical instrument support;
an adjustment mechanism for adjusting the angle between the first and second legs whereby an instrument may be supported on the musical instrument support and may be adjusted to a desired height by adjustment of the musical instrument support without removing the instrument from the adjustable musical instrument stand.

20. The adjustable musical instrument stand of claim 19, wherein the first and second legs are pivotally secured together at a midpoint and the adjustment mechanism comprises a motor mounted on the first leg between the midpoint and either of the top or bottom ends, a screw drive having a threaded screw, the threaded screw being operatively attached to the motor, a receiving bracket mounted on the second leg between the midpoint and either of the top or bottom ends, the receiving bracket for receiving the threaded screw whereby activation of the motor cases the rotation of the threaded screw and adjusts the angle between the first and second legs and the height of the top ends of the first and second legs.

21. The adjustable musical instrument stand of claim 19, wherein the first and second legs are pivotally secured together at a midpoint and the adjustment mechanism comprises a pump, a piston having first and second ends, the first end being attached to the first leg between the midpoint and either of the top or bottom ends, and the second end being attached to the second leg between the midpoint and either of the top or bottom ends, the piston being in operative communication with the pump such that activation of the pump varies pressure within the piston and causes the piston to vary in length and adjusts the angle between the first and second legs and the height of the top ends of the first and second legs.

22. The adjustable musical instrument stand as claimed in claim 19, further comprising a controller for controlling movement of the instrument support by the adjustment mechanism, the controller being actuated by foot.

23. An adjustable musical instrument stand for supporting an instrument, comprising:
first and second legs pivotally secured together, each of the first and second legs having a top end and a bottom end;
a musical instrument support supported by the top ends of the first and second legs; and
an adjustment mechanism for adjusting the angle between the first and second legs, wherein the adjustment mechanism adjusts the angle between the first and second legs while the instrument is supported by the instrument support for adjusting the height of the instrument to a desired height without removal of the instrument from the instrument support.

24. The adjustable musical instrument stand as claimed in claim 23, wherein the adjustment mechanism is hydraulic.

25. The adjustable musical instrument stand of claim 23, wherein the first and second legs are pivotally secured together at a midpoint and the adjustment mechanism includes a motor mounted on the first leg between the midpoint and either of the top or bottom ends, a screw drive having a threaded screw, the threaded screw being operatively attached to the motor, a receiving bracket mounted on the second leg between the midpoint and either of the top or bottom ends, the receiving bracket for receiving the threaded screw whereby activation of the motor cases the rotation of the threaded screw and adjusts the angle between the first and second legs and the height of the top ends of the first and second legs.

26. The adjustable musical instrument stand of claim 23, wherein the first and second legs are pivotally secured together at a midpoint and wherein the adjustment mechanism comprises a pump, a piston having first and second ends, the first end being attached to the first leg between the midpoint and either of the top or bottom ends, and the second end being attached to the second leg between the midpoint and either of the top or bottom ends, the piston being in operative communication with the pump such that activation of the pump varies pressure within the piston and causes the piston to vary in length and adjusts the angle between the first and second legs and the height of the top ends of the first and second legs.

27. The adjustable musical instrument stand as claimed in claim 23, further comprising a controller for controlling movement of the instrument support by the adjustment mechanism, the controller being actuated by foot.
